(19) United States
(12) Patent Application Publication
(10) Pub. No.: US 2021/0095635 A1
(43) Pub. Date: Apr. 1, 2021

(54) Gulf Current Electric Generator

(71) Applicant: Barry DeRan, Lambertville, MI (US)

(72) Inventor: Barry DeRan, Lambertville, MI (US)

(21) Appl. No.: 16/776,591

(22) Filed: Jan. 30, 2020

Related U.S. Application Data
(60) Provisional application No. 62/908,639, filed on Oct. 1, 2019.

(51) Int. Cl. F03B 17/06; F01D 15/10; H02K 7/18

(52) U.S. Cl. CPC F03B 17/065; H02K 7/1823; F01D 15/10

(57) ABSTRACT

A gulf stream electric generator including a first funnel, a second opposite funnel, a propeller, and an electric turbine. The first funnel is a funnel and is placed such that the narrow end connects to an elongated tube. The second funnel is connected to a second end of the elongated tube such that the narrow end is connected to the tube. A propeller is placed within the elongated tube. The propeller is operable coupled to an electric turbine generator. The electric turbine will create an electric charge and send it to a power station for distribution.

### CROSS REFERENCE TO RELATED APPLICATIONS

This application claims the benefit of U.S. Provisional Application No. 62/908,639 filed on Oct. 1, 2019. The above identified patent application is herein incorporated by reference in its entirety to provide continuity of disclosure.

### BACKGROUND OF THE INVENTION

The present invention relates to electric power generation. More particularly, the present invention provides a device that uses under the surface ocean currents to generate electric power.

It is well known that the Earth's ocean contains vast amounts of potential energy. The oceans' currents hold a large amount of kinetic energy. The surface waves make up only part of this energy. There are current streams that exist below the oceans' surface that contain the rest of this energy. These currents exist off of just about every coastline in the world.

Individuals have been attempting to learn how to harness this energy source to create renewable energy for decades. To this point, they have been unsuccessful. While different ways to harness this energy have been created, none have been efficient enough to actually create a viable solution. The amount of time and money it takes to create and maintain these devices makes it impractical.

Consequently, there is a need in for an improvement in the art of power generation. The present invention substantially diverges in design elements from the known art while at the same time solves a problem many people face when using the ocean to efficiently generate electric power. In this regard, the present invention substantially fulfills these needs.

### SUMMARY OF THE INVENTION

The present invention provides a gulf current electric generator wherein the same can be utilized for providing convenience for the user when using a gulf current electric generator. The gulf current electric generator includes a first funnel connected to a first end of an elongated rectangular tube, wherein the first funnel is connected by a narrow end. A second funnel connected to a second end of the elongated tube, wherein the first funnel is connected by the narrow end. The elongated rectangular tube has at least one propeller rotatably coupled therein. The propeller is operably coupled to an electric generator.

Another object of the gulf current electric generator is to have the electric generator be a turbine generator.

The Another object of the gulf current electric generator is to have a buoyancy system, wherein the buoyancy system will allow the gulf current electric generator to be suspended at a chosen depth in the ocean.

Another object of the gulf current electric generator is to have the at least one propeller be positioned horizontally.

Another object of the gulf current electric generator is to have the first funnel be pyramid shaped.

Another object of the gulf current electric generator is to have the second funnel be pyramid shaped.

Another object of the gulf current electric generator is to have the first funnel be removably attached to the elongated tube.

Another object of the gulf current electric generator is to have the second funnel be removably attached.

Another object of the gulf current electric generator is to have a second propeller rotatably couple within the elongated rectangular tube.

Another object of the gulf current electric generator is to have a second electric generator operably coupled to the second propeller.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side view of an embodiment of a gulf current electric generator.

FIG. 2 shows a cross-sectional view of an embodiment of the gulf current electric generator.

FIG. 3 shows a perspective view of an embodiment of a single gulf current electric generator held under the ocean.

FIG. 4 shows a perspective view of an embodiment of a plurality of gulf current electric generators.

FIG. 5 shows a top down view of an embodiment of a propeller for use in the gulf current electric generator.

### DETAILED DESCRIPTION OF THE INVENTION

Reference is made herein to the attached drawings. Like reference numerals are used throughout the drawings to depict like or similar elements of the gulf current electric generator. For the purposes of presenting a brief and clear description of the present invention, a preferred embodiment will be discussed as used for the gulf current electric generator. The figures are intended for representative purposes only and should not be considered to be limiting in any respect.

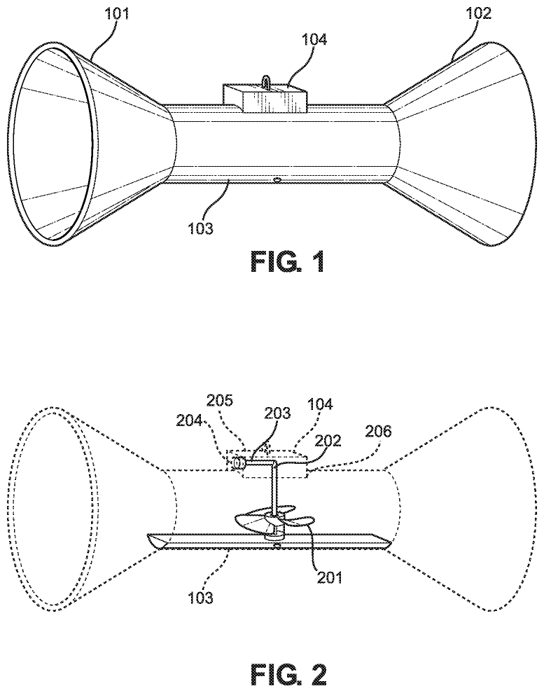

Referring now to FIG. 1, there is shown a side view of an embodiment of a generator. The gulf current electric generator has a first funnel 101. In one embodiment, the first funnel 101 is conical. In another embodiment, the first funnel is pyramid shaped. In this embodiment there is a rectangular open large end opposite of a rectangular open smaller end with four sidewalls creating the pyramid.

The gulf current generator has a second funnel 102. In one embodiment, the second funnel 102 is conical. In another embodiment, the second funnel 102 is pyramid shaped. In this embodiment, there is a rectangular opened large end and a rectangular open smaller end with four sidewalls creating the pyramid.

The first funnel 101 and the second funnel 102 are attached to an elongated tube 103. The first funnel 101 is attached to the elongated tube 103 such that the narrow end of the first funnel 101 is attached to the elongated tube 103. The second funnel is attached to the elongated tube 103 at a second end. The second funnel is attached such that the larger end of the second funnel 102 points in a direction opposite the larger end of the first funnel 101.

In one embodiment, the funnels are removably connected to the elongated tube 103. This will make the funnels easier to replace should they become damaged. In another embodiment, the funnels are permanently attached to the elongated tube 103. In one embodiment the elongated tube 103 is circular. In another embodiment, the elongated tube 103 is rectangular. This rectangular configuration will create a more efficient device. As shown and described below a propeller can be placed in a horizontal fashion. This rectangular shape will better focus the water toward the propeller. This will create a larger amount of pressure better spinning the propeller.

The elongated tube 103 further has a compartment 104 located between the first end and the second end of the elongated tube 103. The compartment 104 can be of different shapes and sizes as needed. The compartment will hold at least the electric generator as described below. In some embodiments the compartment also houses parts of the buoyancy system as described below.

Referring now to FIG. 2, there is shown a cross-sectional view of an embodiment of the generator. The interior of the gulf stream electric generator has two parts. The first part is at least one propeller 201 located within the elongated tube 103. In the shown embodiment, there is only one propeller but in other embodiments more than one propeller may be included. With each propeller comes additional parts to be described in further detail further in. In one embodiment the propeller 201 positioned vertically. In another embodiment, the propeller 201 is positioned horizontally. The at least one propeller 201 will have a number of props 201a. The props 201a will be hit by water spinning the propeller.

The propeller 201 is connected to a spindle 202. The spindle will go from the propeller 201 to the compartment 104. In some embodiments, there will be a waterproof seal 206 between the elongated tube 103 and the compartment 104. The spindle is operably coupled to at turbine electric generator. The electric turbine generator is located within the compartment 104.

The electric turbine generator is comprised of a rotating bar 203 having a magnet 205 located on the end. The electric turbine generator is further comprised of an outer circle of conductive material 204. In embodiments where each device has more than one propeller 201, there will also be an electric turbine generator for each propeller as described. The propeller 201 will spin the spindle 202 spinning the rotating bar 203 which will generate an electric current. This process will be made more efficient due to the funnels. The funnels will increase the speed of the water increasing the spin rate of the propeller 201.

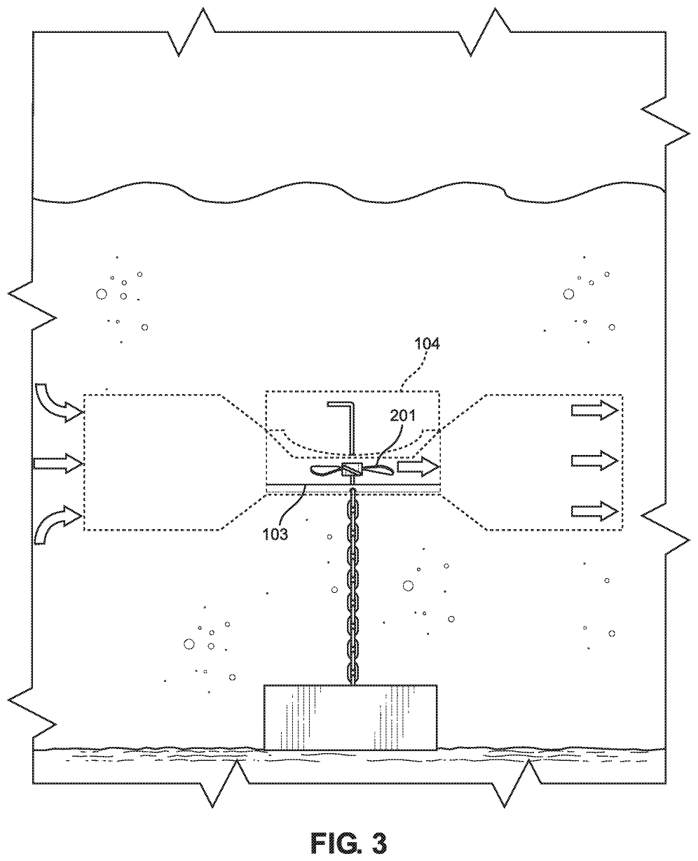

Referring now to FIG. 3, there is shown a perspective view of an embodiment of a single generator held under the ocean. In the shown embodiment, the gulf stream electric generator is attached to the ocean floor. In this embodiment, a buoyancy device will be included with the device in order to keep the device at the proper depth. The device will allow water into the first funnel speeding the water up and through the elongated tube. The water will then leave the second funnel.

In one embodiment the buoyancy device is a plurality of innertubes. In one of these embodiments the buoyancy device includes an air pump. In another embodiment the buoyancy device is at least one ballast tank. In one embodiment the at least on ballast tank is located in the container. In one of these embodiments the buoyancy device includes a water pump. In several embodiments the buoyancy device includes a depth sensor to regulate the depth of the device. In another embodiment the buoyancy device includes a circuitry to control the depth.

In some embodiments the elongated tube 103 narrows even further around the propeller 201. In one embodiment the elongated tube 103 is narrowed causing an oval shape. This will allow for a larger propeller 201. Further this will increase the water pressure as the water passes the propeller 201. In these embodiments the compartment 104 is still located on top of the elongated tube 103.

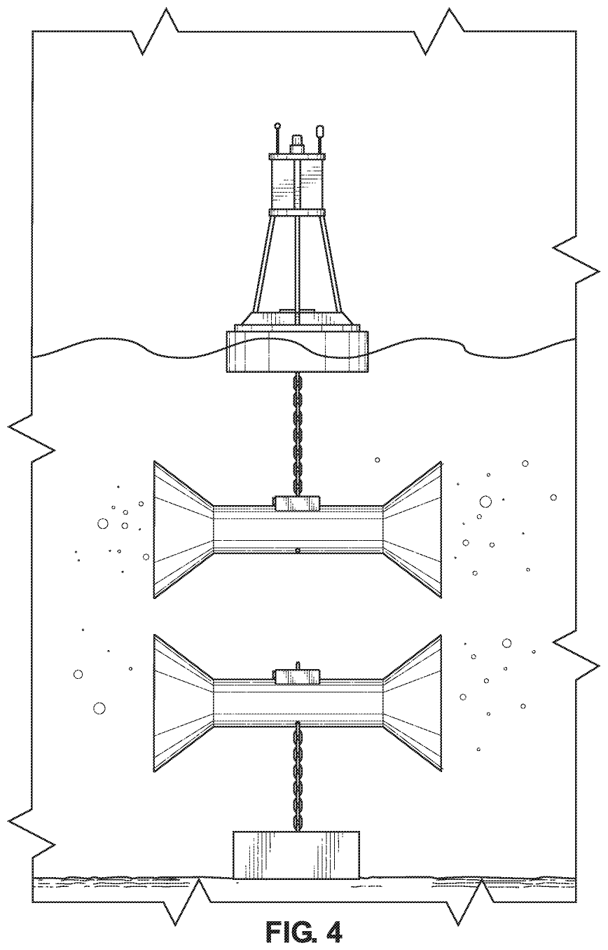

Referring now to FIG. 4, there is shown a perspective view of an embodiment of a plurality of generators. In the shown embodiment, there is more than one gulf stream electric generator. In the shown embodiment, the electric generators are stacked on top of each other. This will allow for a maximizing of the current area to generators. This stacking can help to ensure that the efficiency is capitalized.

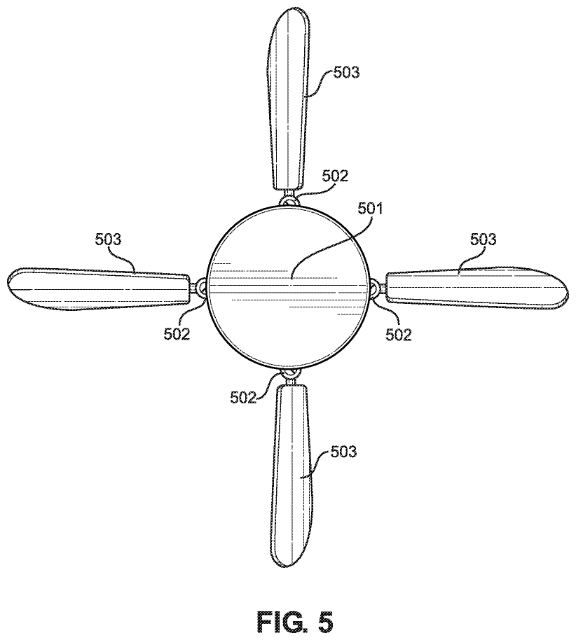

Referring now to FIG. 5, there is shown a top down view of an embodiment of a propeller for use in the gulf current electric generator. In one embodiment the propeller is adapted to allow for the blades 503 to fold. This will allow the propeller blades 503 to collapse making the back pressure lessened as the propeller spins. In one embodiment the propeller blades 503 are attached to the middle of the propeller 501 using a hinge 502. In one embodiment the hinge 502 will only allow the propeller blade 503 to open to a certain point then no further. In one embodiment this point is when the blade is perpendicular to the middle of the propeller 501. This will allow the propeller blades 503 to be pushed open by water pressure then to stop and for the blades 503 to then push the propeller.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A gulf current electric generator, comprising:
a first funnel connected to a first end of an elongated tube, wherein the first funnel is connected by a narrow end of the first funnel;
the elongated tube has a propeller rotatably coupled therein;
the propeller is operably coupled to an electric generator.

2) The gulf current electric generator of claim 1, further comprising a second funnel connected to a second end of the elongated tube, wherein the second funnel is connected by a narrow end of the second funnel.

3) The gulf current electric generator of claim 1, wherein the electric generator turbine generator.

4) The gulf current electric generator of claim 1, further comprising a buoyancy system, wherein the buoyancy system will allow the gulf current electric generator to be suspended at a chosen depth in the ocean.

5) The gulf current electric generator of claim 1, wherein the propeller rotates about a Y axis in relation to the sea floor.

6) The gulf current electric generator of claim 1, wherein the first funnel is conical.

7) The gulf current electric generator of claim 1, wherein the first funnel is pyramid shaped.

8) The gulf current electric generator of claim 1, wherein the first funnel is removably attached to the elongated tube.

9) The gulf current electric generator of claim 2, wherein the second funnel s removably attached.

10) A gulf current electric generator, comprising:
a first funnel connected to a first end of an elongated rectangular tube, wherein the first funnel is connected by a narrow end of the first funnel;
a second funnel connected to a second end of the elongated tube, wherein the first funnel is connected by the narrow end;
the elongated rectangular tube has at least one propeller rotatably coupled therein;
the propeller is operably coupled to an electric generator.

11) The gulf current electric generator of claim 10, wherein the electric generator is a turbine generator.

12) The gulf current electric generator of claim 10, further comprising a buoyancy system, wherein the buoyancy system will allow the gulf current electric generator to be suspended at a chosen depth in the ocean.

13) The gulf current electric generator of claim 10, wherein the at least one propeller is horizontal in relation to a base of the rectangular tube.

14) The gulf current electric generator of claim 10, wherein the first funnel is pyramid shaped.

15) The gulf current electric generator of claim 10, wherein the second funnel is pyramid shaped.

16) The gulf current electric generator of claim 10, wherein the first funnel is removably attached to the elongated tube.

17) The gulf current electric generator of claim 10, wherein the second funnel is removably attached.

18) The gulf current electric generator of claim 10, further comprising a second propeller rotatably couple within the elongated rectangular tube.

19) The gulf current electric generator of claim 18, further comprising a second electric generator operably coupled to the second propeller.
